(19) United States
(12) Patent Application Publication
(10) Pub. No.: US 2013/0335089 A1
(43) Pub. Date: Dec. 19, 2013

(54) THREE DIMENSIONAL ANTENNA SYSTEM FOR MEASURING OSCILLATORY ELECTRIC FIELD STRENGTHS

(71) Applicant: Marius J. Mes, College Station, TX (US)

(72) Inventor: Marius J. Mes, College Station, TX (US)

(21) Appl. No.: 13/523,914

(22) Filed: Jun. 15, 2012

(51) Int. Cl. G01V 3/12

(52) U.S. Cl. 324/332

(57) ABSTRACT

A new three dimensional dipole based antenna system is described used to measure oscillatory electric field strengths. The antenna system is connected to an object (a survey platform) that is stationary or moving in an area of interest in air, over land, on water or under water. This invention aims to reduce the influence of noise sources on electric field strength measurements. Such measurements are generally collected as part of prospecting surveys for minerals or hydrocarbons.

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

Diverse geophysical processes such as seismic and micro-seismic activity, volcanic activity, electric discharges from thunderstorms, vibrations introduced by human activities, and other phenomena cause propagating electromagnetic (EM) vibrations in the earth. The propagation and damping of these electric (E-type) and magnetic (B-type) emissions depends on the physical properties of the material in the earth. Differences in the local strength and phase characteristics of these electromagnetic vibrations can be used as indicators for the presence of hydrocarbons or minerals. These E-type and B-type oscillatory emissions always occur together. They can be measured separately by different sensing systems. My invention only concerns the antenna system used for E-type signals.

Moving survey platforms are used to collect such oscillatory electric signals using a three dimensional dipole antenna system. This antenna system is attached to a stinger or specially designed attachment. In what follows we have also used “stinger” for simplicity as a convenient reference for a specially designed attachment. The survey platforms may consist of manned or unmanned aircraft, drones towed behind aircraft, drones suspended under helicopters, drones towed behind ships, ships, cars, trucks or a stationary object. Suitable electronic equipment is used to digitize and store these signals. The frequency of the signals of interest is in the order of 0.01 Hz to approximately 300 Hz. This invention concerns the antenna sensor system used to collect the oscillatory electric field strengths. Although the description of this invention focuses on a moving survey platform, the same antenna system can be applied to a stationary survey platform.

A description of prior art on which the currently used technology is based can be found in representative patents and patent applications. Examples of patents describing such technology are for example: 1) U.S. Pat. No. 7,002,350, U.S. describes a three dimensional antenna system for a marine oil and gas exploration survey system, 2) U.S. Pat. No. 6,765,383 B1 describes a similar airborne system for drones, and 3) U.S. Pat. No. 4,945,310 describes a single dipole antenna system of a geophysical prospecting tool used to detect electromagnetic radiation. Such a system is not of concern for my invention.

Patent 1) and 2) rely on three curved dipole plate antennas for the measurement of E-type signals. Such antennas do not have uniform directional characteristics about their axis. Such a curved plate antenna system cannot measure the E-type field strength vector in three dimensions as easily and accurately as rod type antennas in a three dimensional dipole configuration. In addition, wires and other electronic equipment are usually located in the area of the antennas, such as inside a stinger. This produces noise on nearby (curved) plate antennas. To obtain a higher signal to noise ratio it is best to move such antennas away from these noise sources and use antennas that point away from the noise source. My invention is based on the need to improve the directional as well as the noise characteristics of the antenna system.

### BRIEF SUMMARY OF THE INVENTION

This invention describes a three dimensional antenna system used to measure oscillatory electric field strengths used in certain survey systems to explore for the presence of commercial quantities of hydrocarbons and minerals. The antenna system is located on a survey platform. My invention is a response to the need to improve the directional characteristics as well as the signal to noise ratio of such antenna system. This invention advances to the state of the art by introducing practical design improvements to a three dimensional set of dipole antennas that improve the signal to noise ratio of the measurements.

### BRIEF DESCRIPTION OF THE SEVERAL VIEWS OF THE DRAWINGS

FIG. 1 illustrates an example of how the invented antenna system could be placed on a survey platform. The three dimensional antenna system consists of three full dipole antenna systems designed in the general direction of mutually perpendicular axes 11, 12 and 13 as depicted in FIG. 1. These axes do not need to intersect. The antenna device is intended to receive electric signals from any direction. This requires three sets of dipole antennas. The rod antenna 14 and the sleeve antenna 15 form one dipole antenna, the rod antennas 16, 17 and 19, 20 form the other dipole antennas. The longitudinal axis of the stinger may coincide with one of the perpendicular antenna axes (here referred to as the X axis 11), but this is not necessary. The axes X, Y and Z may be oriented in any direction.

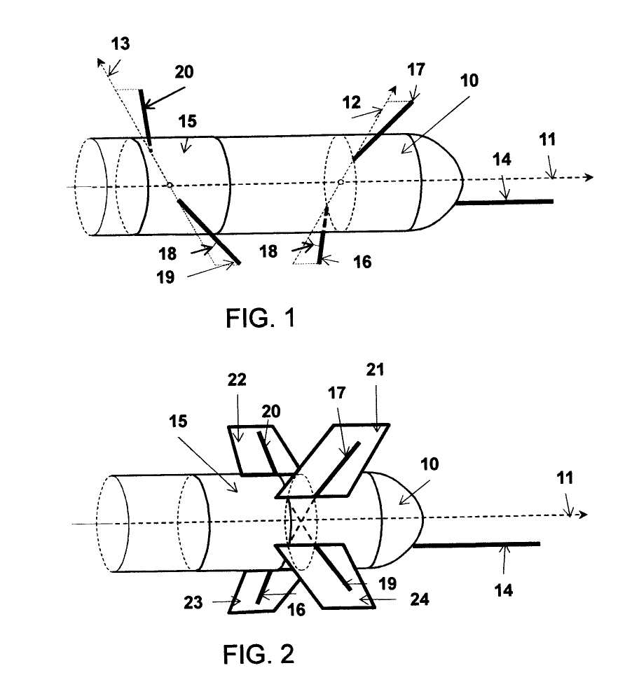

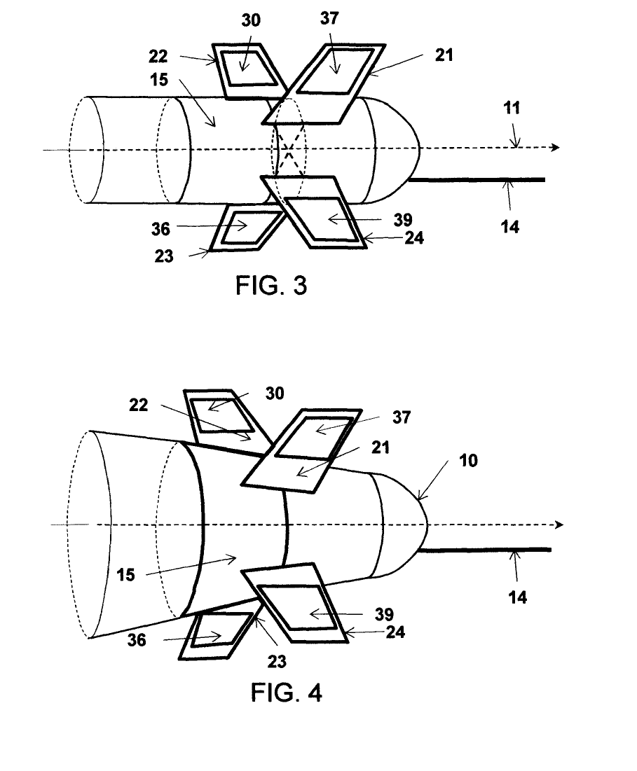

The first dipole antenna system consists of a rod antenna 14 and a specially designed half of a dipole antenna here simply depicted as a sleeve 15 shaped plate or foil antenna wrapped around an object depicted as a stinger 10 in FIG. 1. This sleeve could also be a wrap attached to any survey platform such as, but not limited to a stinger at the tail end of an aircraft, a wing tip, a drone or an underwater object. The cross section of the stinger does not need to be cylindrical. The stinger is however made of material that qualifies as an electrical insulator.

The antenna 15 may also be placed in close proximity of the inside wall of the stinger, its location in relation to antenna 14 is not critical and the axes of rod antenna 15 and sleeve 14 do not need to coincide or even be parallel. The antenna is made of a conducting material and in its cross section it loops around. Thus, for example if mounted on the outside of a circular stinger it would run around the stinger. Antenna 15 may be pierced by, but not limited to, other antennas fins or air foils as long as these do not electrically connect to antenna 15. If a circular electrical path around the stinger 10 is interrupted if such an item is large and it is impractical to maintain such a circular electrical path around the stinger then the different parts of antenna 15 would be electrically connected by wires.

In the general Y (12) direction, depicted in FIG. 1 as a direction perpendicular to the X axis 11 and the Z axis (13), a dipole type antenna is depicted. This dipole antenna consists of rod antennas 16 and 17 attached to the stinger. Antennas 16 and 17 may also be replaced by a dipole that relies on one rod antenna while the other half of the dipole is formed either by the metallic portion of the aircraft or the same plate antenna 15 or a different similarly shaped plate antenna like antenna 15. The rod antennas 16 and 17 (or one of the rod antennas 16 or 17 in the case one rod antenna is used in this direction) in the general Y direction are placed in a plane parallel to the X (11) and Y (12) axes. The antenna rod(s) are installed at a slight angle 18 (such as, but not limited to thirty degrees) with the Y axis, where the angular deviation is generally in the direction of air or water flow.

In the general Z (13) direction, depicted in FIG. 1 as a direction perpendicular to the X axis 11 and the Y axis (12), a dipole type antenna is depicted. This dipole antenna consists of rod antennas 19 and 20 attached to the stinger. Antennas 19 and 20 may also be replaced by a dipole that relies on one rod antenna while the other half of the dipole is formed either by the metallic portion of the aircraft or the same plate antenna 15 or a different similarly shaped plate antenna like antenna 15. The rod antennas 19 and 20 (or one of the rod antennas 19 or 20 in the case one rod antenna is used in this direction) in the general Z direction are placed in a plane parallel to the X (11) and Z (13) axes. The antenna rod(s) are installed at a slight angle (such as, but not limited to thirty degrees) with the Z axis, where the angular deviation is generally in the direction of air or water flow.

The angular rod antenna offset 18 helps prevent or reduce antenna vibrations, which could cause erroneous measurements.

Rod antennas consist of a generic antenna with a length determined by what is practical for use on the survey platform. Generally the rod antenna length will be in the range of approximately ten centimeters to over two meters. Rod antennas may consist of a wire, a stiff rod, a telescoping rod or other designs. The surface of the rod antennas may have designs on them that have the purpose to reduce vibrations in an air flow. All rod antennas are made of a mechanically strong and conducting material similar to the way conventional car antennas are made (For a car the car antenna is one half of the dipole while the car usually forms the other half). The rod antennas and the plate or foil antenna may be electrically insulated by some coating to prevent direct contact with the air or water around them.

FIG. 2 illustrates how the invented antenna system could be placed on a survey platform with four fins 21, 22, 23 and 24. Some survey platforms such as, but not limited to drones towed by ships, aircraft or helicopters use four air foils, tail fins and the like such as one of many types depicted in FIG. 2. The same antenna types described by this invention apply to such a system. Here it is practical to put the antennas 16, 17, 19 and 20 in or on the tail fins in the same configuration as for an antenna system placed on a stinger without fins or no fins near the antenna system. For survey platforms with one, two or three fins, part of the invented antenna system can be installed in or on the available fins as is appropriate while the remaining required antennas can be installed similarly to what is depicted in FIG. 1. Of course the antenna system can also be placed entirely independently from the fins or only be partially incorporated in it. The dipole antenna 14, 15 in the general X 11 direction would be the installed similarly to what is depicted in FIG. 1, here the fins 21, 22, 23 and 24 are shown to pierce antenna 15.

FIG. 3 illustrates how the rod antennas 16, 17, 19 and 20 of FIG. 1 can be replaced by plate antennas 30, 39, 36 and 37 placed on the fins of a survey platform with four fins 21, 22, 23 and 24 if that is considered practical. For a particular fin the antenna plate may be attached to one side of the fin, placed inside the fin or an antenna plate may be placed on both sides of the fins while these plates would be electrically connected to make the plates serve as one antenna. For survey platforms with one, two or three fins, a plate antenna system can be installed in or on the available fins as is appropriate while the remaining required antennas can be installed similarly to what is depicted in FIG. 1. Of course the antenna system can also be placed entirely independently from the fins or only be partially incorporated in it. The dipole antenna 14, 15 in the general X 11 direction would be the installed similarly to what is depicted in FIG. 1, here the fins 21, 22, 23 and 24 are shown to pierce antenna 15.

FIG. 4 illustrates how the antennas 14, 15, 30, 36, 37 and 39 of FIG. 3 can be attached to a survey platform with four fins 21, 22, 23 and 24 and a cone shaped stinger 10 if that is considered practical. One would find such a cone shape for example at the end of some aircraft, drones and other survey platforms. Antenna 15 could be placed on the cone shaped stinger as a cone shaped sleeve.

### DETAILED DESCRIPTION OF THE INVENTION

The purpose of electrical measurements collected from a stationary or moving survey platform is to obtain the strength of the local electric field strength vector. This requires a three dimensional antenna system. Only oscillatory data are of interest. Data usable to calculate corrections for noise to the strength of the local electric field strength vector measurements are not usually available. Examples of sources of noise to electric field strength measurements are electric discharges from the survey platform, motion of the antenna system in the earth magnetic field caused by irregular motion of the survey platform, antenna vibrations, other electric components placed in the stinger or near the antenna system, and other causes. This invention aims to reduce the influence of these noise sources to electric field strength measurements.

Electric discharges from the survey platform are already minimized by the designers of such craft by certain design features. However they cannot always be entirely prevented. In our invention their influence to electric field strength measurements is minimized by using the metallic part of the survey platform as ground to the electronic system and two separate additional antennas as a dipole antenna system.

Antenna vibrations can be caused by lateral air or water flow around an antenna. These vibrations in the earth magnetic field cause noise in the electric measurements by induction. These vibrations can be minimized by providing for antenna rod surfaces that are not smooth or/and by placing the antennas at a slight angle 18 such as depicted in FIG. 8 in the direction of the air or water flow.

Electric components placed in the stinger or nearby the antenna system may emit electromagnetic radiation in the frequency range of interest to the electric measurements. Shielding of such components by metallic wraps or other methods may help reduce the noise from such systems to the electric field strength measurements. We found that the plate antenna 15 depicted in FIG. 1 as part of the dipole antenna system is an effective way to reduce the noise to electric field strength measurements from such systems in addition of serving as an antenna.

This invention can also be applied to stationary survey platforms. The preferred direction of dipole antenna rod 14 of FIG. 1 in that case is upwards or downwards, as the survey situation dictates and the axes 12 and 13 of FIG. 1 would run horizontally with the antennas pointing slightly upwards with angle 18 of FIG. 1. Generally the design depicted in FIG. 1 (or FIG. 4) would be placed in vertical direction.

It will be understood that the above-described embodiments of the invention are illustrative in nature, and that modifications thereof may occur and be made by those skilled in the art. Accordingly, this invention is not to be regarded as limited to the embodiments disclosed herein, but is to be limited only as defined in the appended claims.

1. A three dimensional antenna system for use on a survey platform was invented that is used to measure oscillatory electric field strengths in air or under water consisting of three independent dipole antennas referred to as antenna one, two and three with axes that are generally mutually perpendicular but not necessarily intersecting.

2. A dipole antenna as in claim 1 in which dipole antenna one consists of a rod antenna generally pointing in the direction of flow of the air or water past the rod antenna for moving systems and upwards for stationary systems and a sleeve shaped plate or foil antenna that is wrapped around an object such as, but not limited to a stinger, aircraft wing tank, a towed object or stationary object.

3. A sleeve shaped plate or foil antenna as in claim 2 in which the sleeve shaped plate or foil antenna may have an irregular shape and may have an axis that has no relation to the axis of the rod antenna of antenna one and is attached to material that qualifies as an electrical insulator.

4. Dipole antenna two and three as in claim 1 in which the dipole antenna two and three consist of two rod antennas each wherein the axes of the dipole antennas two and three are mutually perpendicular and the axis of dipole antenna two and three are approximately orthogonal to antenna one, while in moving systems the individual antenna rods are leaning by a small angle not exceeding thirty degrees in the air or water flow direction and in stationary systems the individual antenna rods would be sloped upwards by a small angle not exceeding thirty degrees.

5. The dipole antennas one, two and three as in claim 1 in which the distance between opposing antennas of the respective dipole antennas and the separation in perpendicular direction to the axes of the legs of a dipole antenna can be any practical distance with a maximum distance equal to the size of the survey platform.

6. The dipole antennas one, two and three as in claim 1 in which any rod antenna of the dipole antennas one, two or three may be placed where practical on, in or under the surface of the survey platform or inside any fin, wing or similarly shaped object of the survey platform if the survey platform has any.

7. The dipole antennas one, two and three as in claim 1 in which any rod antenna of the dipole antennas one, two or three may be replaced by a plate antenna where practical and may be placed on, inside or under the surface of any survey platform fin, wing or similarly shaped object of the survey platform if the survey platform has any.

8. The plate antennas as in claim 7 in which any plate antenna may have any practical shape and size that fits the shape of the fin or wing of the survey platform on which it is placed.
